(19) United States
(12) Patent Application Publication
(10) Pub. No.: US 2012/0164296 A1
(43) Pub. Date: Jun. 28, 2012

(54) COOKING UTENSIL SUPPORT DEVICE

(76) Inventor: John R. Beck, Indiana, PA (US)

(21) Appl. No.: 12/978,024

(22) Filed: Dec. 23, 2010

(51) Int. Cl. A45F 5/00; A23L 1/01; F16M 13/02; A47J 37/06

(52) U.S. Cl. 426/523; 248/150; 414/800

(57) ABSTRACT

A portable reconfigurable device for supporting an operable and closable cooking utensil such as a pie iron. The device is movable between a support position wherein an open pie iron may be supported thereon and a storage position wherein a portion of a closed pie iron is supported therein for storage and transport. Other devices and methods for transporting a pie iron are disclosed.

### BACKGROUND

1. Technical Field

The present invention relates to cooking utensils and, in various embodiments, to portable enclosure and carrying devices for supporting cooking utensils therein and, in some other embodiments, to devices that are reconfigurable from an open position wherein a cooking utensil such as an open pie iron may be supported thereon and to a closed position wherein the pie iron may be stored and transported therein.

2. Background

Over the years, a myriad of devices and utensils have been developed for cooking sandwiches, finger foods, snacks and the like over an open fire or flame. One such food item is known as a “mountain pie” and may comprise a grilled, pressed and/or toasted sandwich or the like that is heated in a device commonly referred to as a “mountain pie iron” or in short, a “pie iron”. A pie iron typically consists of two, somewhat dished, metal castings that are hinged together to form a single cooking cavity when closed. The castings are commonly formed from iron or aluminum. Elongated metal rods with handle portions extend from the castings so the user can easily maneuver the device over a campfire or other open flame.

To make a mountain pie using a pie iron, one typically applies butter to the outsides of 2 pieces of bread and lays them in the dished castings. A food stuffing or filling is then placed on the bread. A variety of different types of fillings have been used. For example, the fillings may comprise various types and forms of meats, cheeses, sauces, fruit fillings, etc. The castings are then closed and the closed cooking cavity is supported over the flame by the handles. A few minutes over the heat and a perfectly toasted sandwich or “mountain pie” emerges from the iron.

Often when making mountain pies, there is not an available table to set the hot pie iron on. Thus, the user commonly places the hot pie iron on a rock or the ground which can result in the introduction of grass, dirt or other foreign matter into the pie iron. Also the pie iron commonly becomes soiled with soot and charcoal stains from the heat source making it difficult to transport without soiling the user's clothes or surroundings with the soot and black charcoal.

Accordingly, there is a need for cooking utensil supporting and transporting device that may be used in connection with a pie iron that addresses at least some of the shortcomings discussed above.

The foregoing discussion is intended only to illustrate some of the shortcomings present in the field of the invention at the time, and should not be taken as a disavowal of claim scope.

### SUMMARY

In accordance with general aspects of at least one form, there is provided a portable device for supporting at least one pie iron. At least one embodiment includes a first support portion that defines a first recessed support area and a second support portion that defines a second recessed support area. The first and second support portions are movable relative to each other from a closed position wherein the second recessed support area cooperates with the first recessed support area to form a storage cavity and an open position wherein at least a portion of at least one pie iron is supportable thereon. At least one leg member is removably attachable to the device in a first position when the device is in the open position to support the device above a surface and in a second position wherein the at least one leg member releasably retains the first and second support portions in the closed position.

In accordance with other general aspects of at least one form, there is provided a method of cooking a mountain pie over a heat source. Various embodiments comprise providing a portable device for supporting at least one pie iron in an open position and in a closed position. At least one embodiment includes a first support portion that defines a first recessed support area and a second support portion that defines a second recessed support area. The first and second support portions are movable relative to each other from a closed position wherein the second recessed support area cooperates with the first recessed support area to form a storage cavity and an open position wherein at least a portion of at least one pie iron is supportable thereon. At least one leg member is removably attachable to the device in a first position when the device is in the open position to support the device above a surface and in a second position wherein the at least one leg member releasably retains the first and second support portions in the closed position. The method further comprises orienting the device in the open position and supporting the open device above the ground. One form of the method further comprises opening a pie iron and placing the open pie iron onto the open device. In various forms, the method includes placing food items into the open pie iron and then closing the pie iron. The closed pie iron is then removed from the open device and heat is applied thereto.

In accordance with still other general aspects of at least one form, there is provided a reconfigurable device for supporting a cooking utensil in an open position and for transporting the cooking utensil when the cooking utensil is in a closed position. In various forms, the device comprises a first support portion that defines a first recessed support area. A second support portion that defines a second recessed support area is pivotally coupled to the first support portion such that the first and second support portions are selectively movable relative to each other from a storage position wherein the second recessed support area cooperates with the first recessed support area to form a storage cavity sized to support a portion of the cooking utensil therein when in the closed position and a support position wherein the cooking utensil is supportable thereon when the cooking utensil is in the open position. The device, in various forms, has a latch arrangement for releasably retaining the first and second support portions in the storage position.

In accordance with yet other general aspects, there is provided a method for transporting a pie iron that has a first dished portion with an elongated handle protruding therefrom. The first dished portion is movably coupled to a second dished portion that has a second elongated handle protruding therefrom such that the first and second dished portions are movable from an open position to a closed position to form a sandwich enclosure. In various forms, the method comprises moving the first and second dished portions of the pie iron to the closed position to form the sandwich enclosure and placing the sandwich enclosure into a transport device. The method further comprises closing the transport device around the sandwich enclosure such that the sandwich enclosure is substantially enclosed within the transport device while permitting the elongated handle portions to protrude outward from the transport device to enable the transport device to be transported thereby.

### BRIEF DESCRIPTION OF DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a plan view of a cooking utensil supporting device in an open position;

FIG. 2 is a side elevational view of the cooking utensil supporting device of FIG. 1 with the legs thereof in a first supporting position;

FIG. 3 is a side elevational view of the cooking utensil supporting device of FIGS. 1 and 2 in a closed or storage position wherein the legs are in a second latching position;

FIG. 4 is a plan view of a conventional pie iron in an open position;

FIG. 5 is a side elevational view of the conventional pie iron of FIG. 4 in a closed position;

FIG. 6 is a plan view of the cooking utensil supporting device in an open position and supporting an open pie iron thereon;

FIG. 7 is a side elevational view of the cooking utensil supporting device and pie iron of FIG. 6;

FIG. 8 is a side elevational view of the cooking utensil supporting device in a closed or storage position with a portion of the pie iron stored therein;

FIG. 9 is a plan view of a cooking utensil supporting device embodiment in an open position and supporting two closed pie irons therein;

FIG. 10 is a side elevational view of the cooking utensil supporting device and pie irons of FIG. 9;

FIG. 11 is a plan view of a cooking utensil support/transporting device of another embodiment of the present invention supporting an open pie iron thereon;

FIG. 12 is a side elevational view of the cooking utensil transporting device and pie iron of FIG. 11; and

FIG. 13 is a side elevational view of a cooking utensil transporting device of another embodiment of the present invention installed on a portion of a pie iron.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the various embodiments of the present invention is defined solely by the claims. The features illustrated or described in connection with one exemplary embodiment may be combined with the features of other embodiments. Such modifications and variations are intended to be included within the scope of the present invention.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present invention.

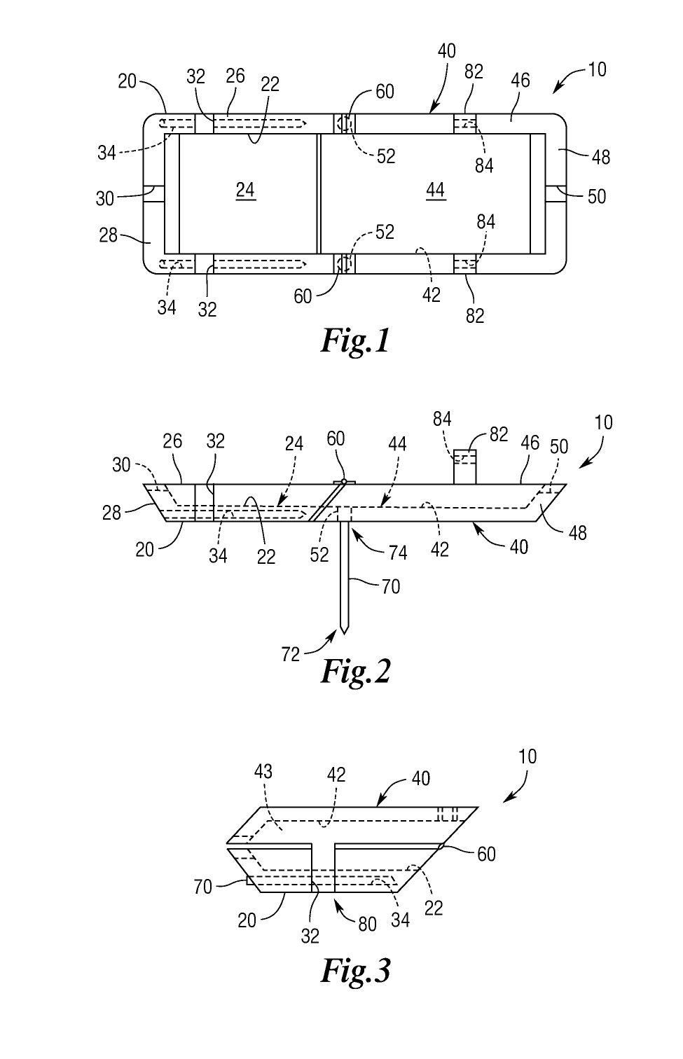

Referring to FIGS. 1 and 2, there is shown one embodiment of a portable cooking utensil support device generally represented as 10 in an “open” position. The portable device 10 of this embodiment includes a first support portion 20 that includes a first recessed support area 22 that is sized to support a portion of a pie iron therein. In other embodiments, however, the first support portion 20 may be substantially planar with no recessed portion provided. The first support portion 20 may be fabricated from metal such as, for example, iron, steel, stainless steel, aluminum, titanium, etc. The first support portion 20 may also be fabricated from other heat resistant materials or composite materials that are heat resistant. As used herein, the term “heat resistant” refers to a characteristic of the materials employed that enables the device to support a pie iron that was removed from a heat source such as a campfire, conventional cooking oven, etc. and immediately supported thereon without degrading or damaging the device to a point wherein the device can no longer be used as intended.

The first support portion 20 may be of cast, welded, machined, pressed, folded, formed, etc. construction. In the embodiment depicted in FIGS. 1 and 2, the first recessed support area 22 comprises a first recessed support surface 24 that has an upstanding first rim 26 that extends around three sides thereof. In other embodiments, however, the upstanding first rim 26 may be provided on at least one side and in still other embodiments, no upstanding rim 26 may be provided. In the embodiment depicted in FIGS. 1 and 2, the portion of the upstanding first rim 26 that forms an end wall 28 has a first handle slot 30 therein for receiving a portion of a handle shaft of a pie iron therein as will be discussed in further detail below.

The embodiment depicted in FIGS. 1 and 2 includes a second support portion 40 that defines a second recessed support area 42 that is sized to support another portion of a pie iron therein. In other embodiments, particularly in those wherein the first support portion 20 is planar, the second support portion may be substantially planar without a recessed portion. The second support portion 40 may be fabricated from the same material or materials from which the first support portion 20 is fabricated from, utilizing the same or similar manufacturing methods. In the embodiment depicted in FIGS. 1 and 2, the second recessed support area 42 includes a second recessed support surface 44 that has a second upstanding rim 46 that extends around three sides thereof. In other embodiments, the second upstanding rim 46 is only provided on at least one side thereof and, in still other embodiments, no second upstanding rim 46 is provided. In the embodiment depicted in FIGS. 1 and 2, the portion of the upstanding second rim 46 that forms an end wall 48 has a second handle slot 50 therein for receiving a portion of a pie iron handle shaft therein.

The second support portion 40 is movably coupled to the first support portion 20 such that the second support portion 40 is movable from an “open” or “support” position (FIGS. 1, 2, 6, and 7) wherein the second recessed support surface 44 is substantially co-planar with the first recessed support surface 24 to a “closed” or “storage” position (FIG. 3) wherein the first recessed support area 22 and the second recessed support area 42 cooperate to form a storage cavity 43 therein. In at least one embodiment, the second support portion 40 is pivotally attached to the first support portion 20 by at least one hinge arrangement 60. The embodiment depicted in FIG. 1 employs two hinge arrangements 60. Other hinge and pivot arrangements as well as other movable attachment methods may be employed to couple the first support portion 20 to the second support portion 40 such that they may be selectively moved from the closed or storage position to the open or support position. In still other embodiments, the first and second support portions 20, 40 may be removably detachable from each other such that they may be separated from each other and then affixed together or otherwise supported relative to each other in the open or support position and then detached from each other again and attached together in the storage position after the pie iron 100 has been placed therein. Thus, the protection afforded to at least some of the various embodiments of the present invention should not be limited to designs that employ a hinge, hinges or hinge-like arrangements that permanently affix the first and second support portions together.

Various embodiments of the device 10 further include at least one leg 70 that is configured to support the device 10 above a surface such as the ground. In the embodiment depicted in FIGS. 1-3, two legs 70 are employed. In other embodiments, one leg or more than two legs are employed. The leg(s) 70 may consist of, for example, a metal rod, spike or the like. As can be seen in FIG. 2, the legs 70 are configured to be removably attachable to the second support portion 40 such that the legs 70 protrude downward therefrom. In at least one embodiment, to facilitate insertion of the legs 70 into the ground or other surface, one end 72 may be pointed or somewhat sharpened. The other end 74 of each leg 70 is configured to be received within a corresponding hole or socket 52 provided in the second support portion 40. The end 74 of leg 70 may be threaded to be threadably received in the hole or socket 52. However, other retention arrangements (e.g., frictional fits, twist lock formations, etc.) may be employed to removably affix the ends 74 of the legs 70 to the second support portion 40 in a first supporting orientation. Also in other embodiments, the end 74 of each of the leg(s) 70 may be formed or otherwise provided with at least one formation that would simply support the device on a surface without penetrating the surface.

Various forms of the device 10 may further include a retainer latch arrangement 80 for releasably retaining the device 10 in the closed position. For example, at least one retention lug 82 may be provided on the second support portion 40 that is configured to be received in a corresponding retention cavity 32 formed in the first support portion 20 when the device 10 is in the closed position. In alternative embodiments, the retention lugs 82 may be provided on the first support portion 20 and the corresponding retention cavities may be provided in the second support portion 40. In the embodiment depicted in FIG. 1, for example, two retention lugs 82 are provided on the second support portion 40 and two retention cavities 32 are provided in the first support portion. Because various embodiments may employ the leg(s) 70 to retain the device 10 in the closed position, the device may employ a number of retention lugs 82 that match the number of legs 70. For example, when the device is in the closed position, the leg(s) 70 are detached from the holes 52 in the second support portion 50 and inserted into corresponding transverse retention holes 34 provided in the first support portion 20. The retention holes 34 align with corresponding retention passage 84 provided through each retention lug 82 to thereby retain the retention lug 82 in its corresponding retention cavity 32 in the first support portion 20. In such arrangement, the leg(s) 70, when in the stored position, serve to latch or retain the device 10 in its closed position as illustrated in FIG. 3.

In other embodiments, the first and second support portions 20, 40 may be retained in the stored position by at least one other conventional latching mechanism attached to one of the first and second support potions 20, 40 and releasably engagable with the other of the first and second support portions 20, 40. For example, one or more conventional luggage-type latches that are selectively releasable may be employed. Also, in other embodiments, the leg(s) 70 may be releasably attached to the device 10 by clips, straps, latches and other fastener arrangements when in the stored position.

Various portions of a pie iron are commonly fabricated from iron material, hence the name “pie iron”. As used herein, however, the term “pie iron” refers to those devices designed to facilitate the cooking of a food item such as a sandwich (e.g., “mountain pie”) over a heat source that are fabricated from various materials including but not limited to iron, steel, aluminum, heat resistant composite materials, etc. Thus, the term “pie iron” as used herein should not be limited to those devices that are manufactured from iron materials. Furthermore, those of ordinary skill in the art will understand that a variety of different shapes and sizes of pie irons exist. For example, one form of pie iron is designed to facilitate the cooking of a single sandwich or mountain pie. Other pie irons are designed to facilitate the cooking of a plurality of sandwiches or mountain pies at the same time. The size and shapes of the component portions of the devices of various embodiments of the present invention may be configured to accommodate a particular size and shape of pie iron without departing from the spirit and scope of the present invention. Accordingly, the scope and protection afforded to the embodiments disclosed and claimed herein should not be limited to a particular shape or size of pie iron.

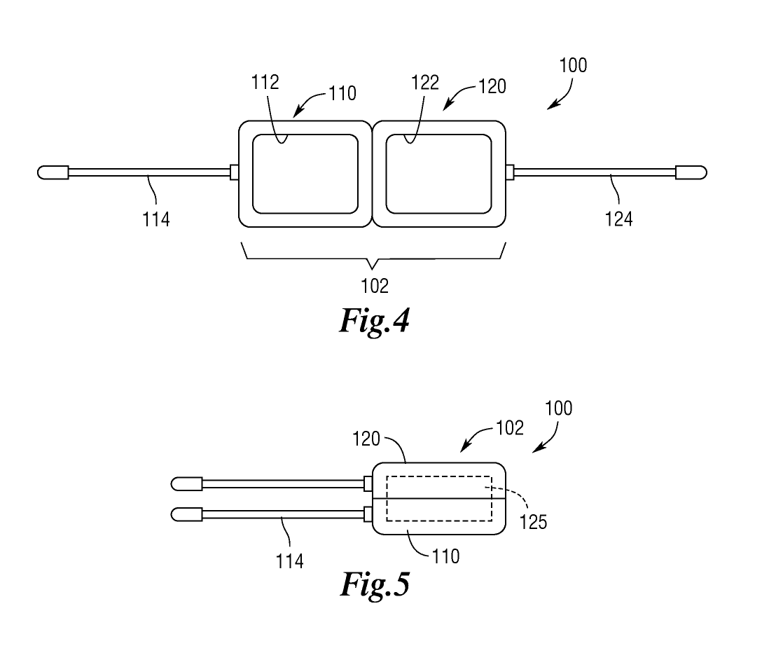

FIGS. 4 and 5 depict a common exemplary pie iron 100. As can be seen in those Figures, a common pie iron 100 comprises an iron sandwich enclosure 102 that has a pair of handles 114, 124 attached thereto. The iron sandwich enclosure 102 generally comprises a first iron segment 110 that is hinged to a second iron segment 120. The first iron segment 110 has a first sandwich cavity segment 112 therein that cooperates with a second cavity segment 122 in the second iron segment 120 to form a cooking cavity 125 within the enclosure 102. A first handle 114 is attached to the first iron segment 110 and a second handle 124 is attached to the second iron segment 120 to enable the user to pivot the iron segments 110, 120 between an open position (FIG. 4) and a closed position (FIG. 5) and to suspend the sandwich enclosure 102 over an open flame such as a campfire or the like or other heat source (e.g., oven burner, etc.).

While a myriad of mountain pie recipes exist, the pie iron 100 may be employed, for example, by buttering a first piece of bread and placing it into the first cavity segment 112 and buttering a second piece of bread and placing it into the second cavity segment 122 when the iron 100 is in the open position. The filling material, which may comprise, for example, cheese, pizza sauce, tomato sauce, pepperonis and or other meats, fish, shrimp, cheese, pie fillings, fruit, etc. is then placed on one or both pieces of bread and the iron segments 110, 120 are then closed. The handles 114, 124 are then used to support the sandwich enclosure 102 over a source of heat.

Many times when making mountain pies, a table or other support surface is not readily available. Thus, the user typically sets the hot pie iron on a rock or the ground which can lead to the introduction of grass, dirt or other foreign matter into the sandwich enclosure 102. Also, because the pie iron is placed directly into the fire, soot and charcoal tend to adhere to the outside of the pie iron thus making a mess of storing the iron when not in use. Various embodiments of the device 10 may solve these problems.

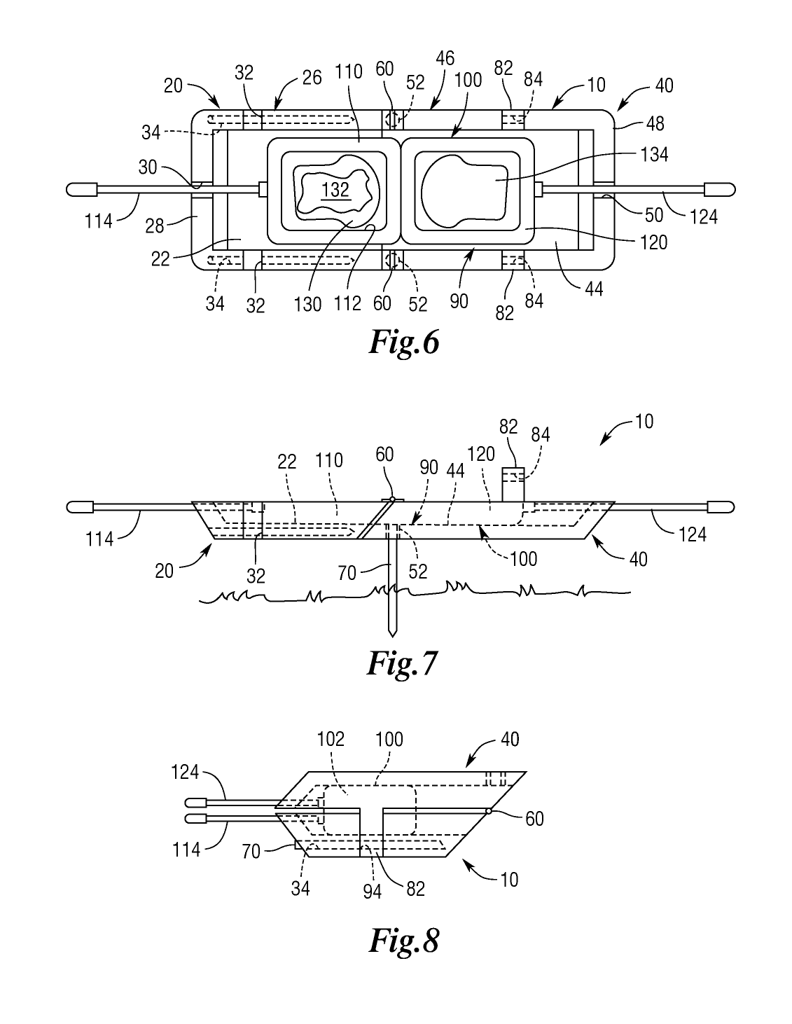

FIGS. 6 and 7 illustrate use of a device 10 when cooking a conventional mountain pie in a pie iron 100. As can be seen in FIG. 7, the legs 70 are attached to the second support portion 40 by threading the end 74 of each leg 70 into a corresponding hole 52 in the second support portion 40. In other embodiments, the legs may simply be inserted into holes or sockets or otherwise removably coupled to one of the first and/or second support portions 20, 40. In the depicted embodiment, the pointed end 72 of each leg 70 is inserted into the ground to support the open device 10 above the ground. In alternative embodiments, the leg(s) 70 may be configured to simply support the device 10 on the surface without penetrating into it. The substantially co-planar support surfaces 24 and 44 form a table surface 90 configured to support an open pie iron 100 thereon. The first and second rims 26 and 46 serve to prevent the pie iron segments 110, 120 from sliding off of the table surface 90. A portion of the first handle 114 may be cradled in the first slot 30 and a portion of the second handle 124 may be cradled in the second slot 50 as shown in FIG. 6.

A first piece of buttered bread 130 is placed into the first cavity segment 112 and filling 132 is placed thereon. A second piece of buttered bread 134 is either placed into the second cavity segment 122 or onto the filling 132 with the buttered side down and then the pie iron 100 is closed. The handles 114, 124 are then used to suspend the sandwich enclosure 102 over a source of heat. Once the mountain pie has been sufficiently heated, the user may return the hot sandwich enclosure 102 onto the table surface 90 to enable the pie iron 100 to be returned to the open position to provide access to the mountain pie. Such arrangement prevents dirt and debris from entering the pie iron and/or the finished mountain pie itself.

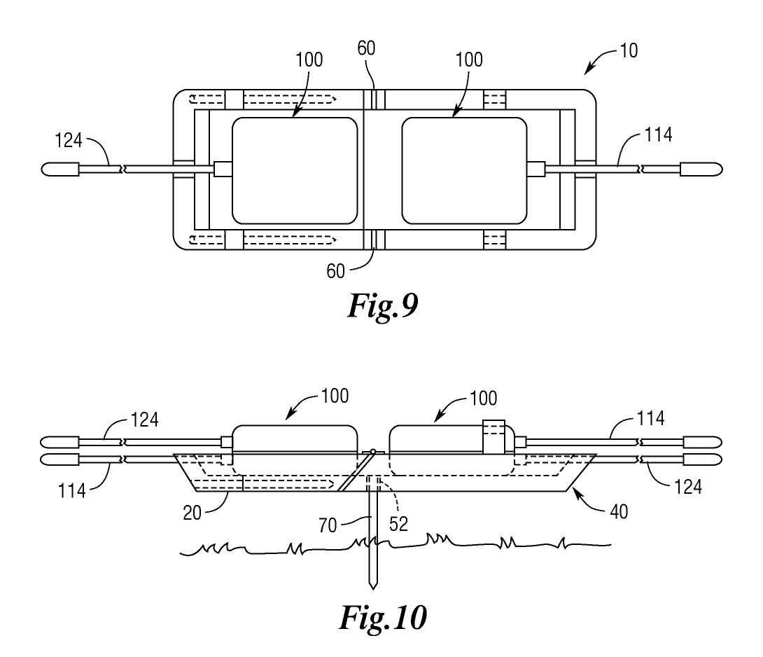

Various embodiments of the device 10 can also be used to store a pie iron 100 after use. For example, when the cooking process has been completed, the user may place the closed pie iron 100 onto the first support surface 22 and the second support portion 40 may be pivoted to the closed position as shown in FIG. 8. The legs 70 are detached from the second support portion 40 and are inserted into the corresponding retention holes 34 to retain the device 10 in the closed position wherein the sandwich enclosure portion 102 is completely encapsulated within the device 10. Such arrangement prevents the sandwich enclosure portion 102 of the pie iron 100, which may have charcoal and soot thereon, from soiling the user's clothes, etc. The closed device/pie iron assembly may then be carried by the pie iron handles 114, 124. FIGS. 9 and 10 illustrate use of the device 10 to support, for example, two pie irons 100 when each is in a closed position prior to or after use.

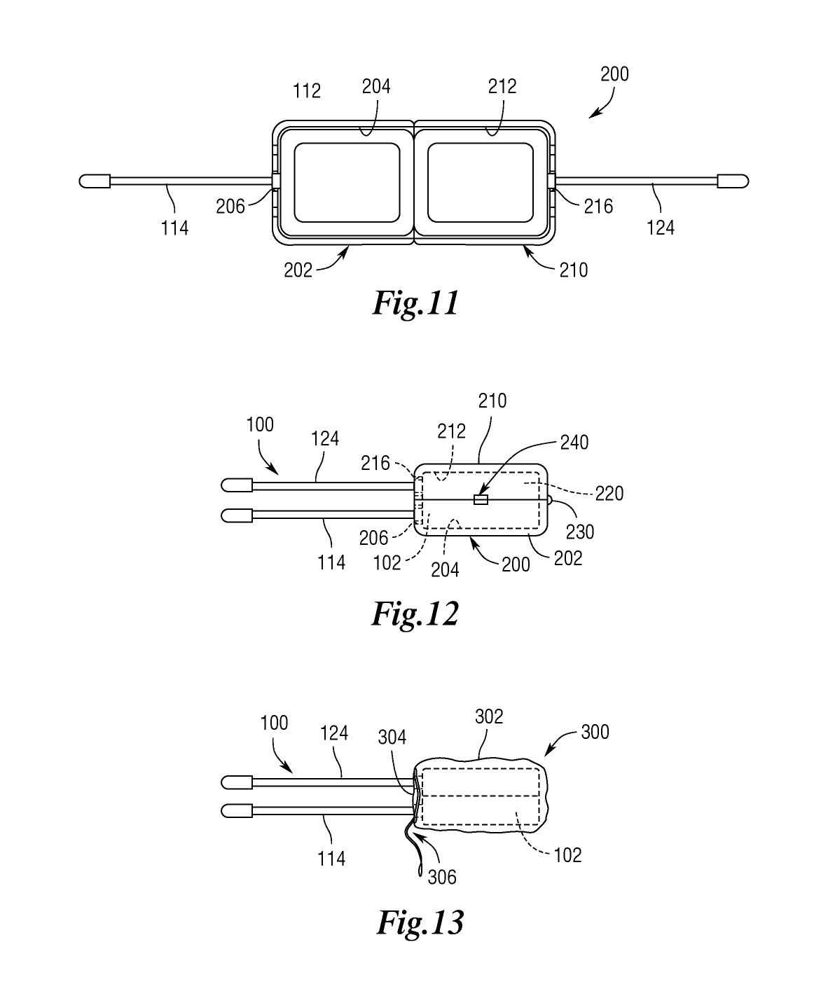

FIGS. 11 and 12 illustrate another embodiment of the present invention which comprises a pie iron transport and storage device 200. As can be seen in those Figures, the storage device 200 comprises a first support portion 202 that has a first cavity 204 formed therein. A second support portion 210 is complementarily sized relative to the first support portion 202 and has a second cavity there 212 therein. When the second support portion 210 is joined to the first support portion 202, the first cavity 204 and the second cavity 212 cooperate to form an pie iron-receiving cavity generally designated as 220 that is sized to receive the closed sandwich enclosure 102 therein as shown in FIG. 12. As can be seen in FIG. 12, in at least one embodiment, the first support portion 202 is pivotally coupled to the second support portion 210 by a hinge or hinges 230. In other embodiments, the first support portion 202 may be removably couplable to the second support portion 210 to form the storage cavity 220 and then detached from each other to enable the pie iron 100 to be removed from the device 200. Such embodiments may employ one or more latch arrangements or other attachment methods for detachably affixing the two support members 202, 210 together.

In various embodiments, the first and second support members 202, 210 may be fabricated from metal such as, for example, iron, steel, stainless steel, aluminum, titanium, etc. The first and second support portions 202, 210 may also be fabricated from other heat resistant materials or composite materials that are heat resistant. In still other embodiments, however, the first and second support members 202, 210 may be fabricated from non-heat resistant materials such as plastic for example and be attached together by a living hinge or other attachment arrangement. Such devices may be used to store and/or transport a pie iron 100 that has cooled before being placed into the device 200.

As can be seen in FIGS. 11 and 12, the first support portion 202 has an opening 206 formed therein that is sized to permit the handle portion 114 to protrude therethrough. Similarly, the second support portion has an opening 216 therein to permit the handle portion 124 to protrude therethrough. Such openings 206, 216 may be configured and sized to accommodate the handle portions of a particular pie iron. When the device 200 is closed around the sandwich enclosure 102 as shown in FIG. 12, the enclosure 102 which may be are soot-covered or otherwise soiled with charcoal, is completely contained within the device 200. One or more latches, snaps, etc. 240 may be provided to retain the device 200 in the closed position. See FIG. 12. The user may then carry/transport the device/pie iron assembly by means of the handles 114, 124 without getting the soot/charcoal on his or her clothes and/or surroundings.

FIG. 13 illustrates yet another support device 300 for substantially enclosing and/or transporting a closed pie iron 100. As can be seen in that Figure, various embodiments of the device 300 comprises a flexible enclosure or bag 302 that has an opening 304 therein through which the sandwich enclosure 102 may be inserted. In the depicted embodiment, a draw-string arrangement 306 is provided to cinch the device 300 around the sandwich enclosure portion 102 of the pie iron 100. Other arrangements such as, for example, hook and loop straps (Velcro®), snaps, etc. may be employed. In various embodiments, the device 300 may be fabricated from a flexible heat-resistant material. In other embodiments, the device 300 may be fabricated from non-heat-resistant material such as plastic, etc. for storing and transporting a cool iron.

Thus, various embodiments provides for a heat resistant table for preparing the mountain pie and also keeps the soot and charcoal confined to the inside of the invention when the pie iron is not in use. While the various embodiments have been described as having exemplary designs, these embodiments may be further modified within the spirit and scope of the disclosure. This application is therefore intended to cover any variations, uses, or adaptations of the various embodiments using their general principles. Further, this application is intended to cover such departures from the present disclosure as come within known or customary practice in the art to which this invention pertains.

What is claimed is:

1. A portable device for supporting at least one pie iron, said device comprising:
a first support portion defining a first recessed support area;
a second support portion defining a second recessed support area, said second support portion being movably supported relative to said first support portion such that said first and second support portions are selectively movable relative to each other between a closed position wherein said second recessed support area cooperates with said first recessed support area to form a storage cavity and an open position wherein at least a portion of at least one pie iron is supportable thereon; and
at least one leg member removably engagable with said device in a first position to support said device above a surface and in a second position wherein said at least one leg member releasably retains said first and second support portions in said closed position.

2. The portable device of claim 1 wherein said first recessed support area has a first support surface and wherein said second recessed support area has a second support surface such that when said device is in said open position, said second support surface is substantially coplanar with said first support surface.

3. The portable device of claim 1 wherein said first recessed support area has a first rim that protrudes from at least a portion of said first recessed surface and wherein said second recessed support area has a second rim that protrudes from at least another portion of said second recessed surface.

4. The portable device of claim 3 wherein at least a portion of at least one of said first and second rims has a slot therein to receive a portion of a pie iron therein.

5. The portable device of claim 1 wherein one of said first and second support portions has at least one retainer latch that is oriented to be received in a corresponding retainer cavity in the other of said first and second support portions when said first and second support portions are in said closed position, said at least one retainer latch having a hole therethrough for receiving a portion of at least one of said at least one leg members therethrough to releasably latch said first and second support portions in said closed position.

6. The portable device of claim 1 wherein one of said first and second support portions is configured to removably receive a portion of said at least one leg therein.

7. The portable device of claim 6 wherein said second support portion has a socket therein configured to removably receive a portion of one of said at least one leg members therein.

8. The portable device of claim 7 wherein said socket is configured to threadably engage said one of said at least one leg members.

9. The portable device of claim 1 wherein one end of said at least one leg member is configured to be inserted into the ground.

10. The portable device of claim 6 wherein said at least one leg member comprises two leg members and wherein said first support portion is configured to releasably engage said leg members when said first and second support portions are in said open position.

11. The portable device of claim 10 wherein said first support portion has a threaded socket therein corresponding to each said leg for threadably engaging a portion of said corresponding leg therein.

12. The portable device of claim 1 wherein said at least one leg member is completely received within one of said first and second support portions when said first and second support portions are in said closed position.

13. A method of cooking a mountain pie over a heat source comprising:
providing a portable device of claim 1;
orienting the device in the open position;
supporting the device in the open position;
opening a pie iron;
placing the open pie iron onto the open device;
placing food items into the open pie iron;
closing the pie iron;
removing the closed pie iron from the open device; and
applying heat to the closed pie iron.

14. The method of claim 13 wherein said applying heat to the closed pie iron comprises applying heat to the closed pie iron for a desired period of time and wherein said method further comprises:
reopening the heated pie iron; and
supporting the reopened heated pie iron on the open device.

15. The method of claim 14 further comprising:
removing the food items from the open pie iron;
reclosing the pie iron; and
reconfiguring the device to a closed position wherein a sandwich cavity portion of the pie iron is encapsulated by the device.

16. A reconfigurable device for supporting an operable and closable cooking utensil, said device comprising:
a first support portion defining a first recessed support area;
a second support portion defining a second recessed support area, said second support portion being pivotally coupled to said first support portion such that said first and second support portions are selectively pivotable relative to each other from a storage position wherein said second recessed support area cooperates with said first recessed support area to form a storage cavity sized to support a portion of the cooking utensil therein when the cooking utensil is in a closed position and a support position wherein the cooking utensil is supportable thereon when the cooking utensil is in an open position; and
a latch arrangement for releasably retaining said first and second support portions in said storage position.

17. The device of claim 16 wherein said latch arrangement comprises at least one leg member attachable in a first support position to said device when said device is in said support position, and a second latch position wherein at least one of said at least one leg member releasably retains the device in said storage position.

18. The device of claim 17 wherein each said leg is threadably attachable to one of said first and second support portions when the device is in said support position.

19. The device of claim 17 wherein said latch arrangement further comprises:
at least one latch lug protruding from said second support portion and configured to be received in a corresponding retention cavity in the first support portion when said device is in said storage position; and
a retention hole in said first support portion sized to receive a portion of said leg therethrough when said device is in said storage position to retain said latch lug in said corresponding retention cavity.

20. A reconfigurable device for supporting a cooking utensil, said device comprising:
a first support portion defining a first support surface;
a second support portion defining a second support surface and being movably coupled to said first support portion such that said first and second support portions are selectively movable relative to each other from a storage position to a support position wherein the first and second support surfaces cooperate to form a cooking utensil support surface;
at least one leg member removably engagable with said device in a first position to support said device;
means for latching the first and second support portions in the storage position; and
means for releasably affixing said at least one leg member to said device when in said storage position.

21. A method for transporting a pie iron having a first dished portion with an elongated handle protruding therefrom and being movably coupled to a second dished portion that has a second elongated handle protruding therefrom wherein the first and second dished portions are movable from an open position to a closed position to form a sandwich enclosure, said method comprising:
moving the first and second dished portions of the pie iron to the closed position to form the sandwich enclosure;
placing the sandwich enclosure into a transport device;
closing the transport device around the sandwich enclosure such that the sandwich enclosure is substantially enclosed within the transport device while permitting the elongated handle portions to protrude outward from the transport device to enable the transport device to be transported thereby.

22. The method of claim 21 wherein the transport device comprises:
a first support portion configured to receive the first dish portion therein; and
a second support portion configured to receive the second dish portion therein, the second support portion being movably coupled to the first support portion and being selectively movable between an open position and a closed position and wherein said placing comprises moving the first and second support portions to the open position and wherein said placing comprises placing the sandwich enclosure in the first support portion and wherein said closing comprises moving the second support portion into the closed position and wherein said method further comprises latching the first and second support portions in the closed position.

23. The method of claim 21 wherein the transport device comprises a flexible enclosure having an opening in a portion thereof and wherein said placing comprises inserting the sandwich enclosure through the opening into the flexible enclosure such that portions of the elongated handles protrude outward through the opening and wherein said closing comprises cinching the opening around the outwardly protruding handle portions.
